(19) United States
(12) Patent Application Publication
(10) Pub. No.: US 2004/0113498 A1
(43) Pub. Date: Jun. 17, 2004

(54) Electrical isolation interface for medical instrumentation

(76) Inventor: Thomas Kroenke, Nederland, CO (US)

Correspondence Address: Thomas Kroenke, 10 Evergreen Way, Nederland, CO, 80466, US

(21) Appl. No.: 10/316,335

(22) Filed: Dec. 12, 2002

(51) Int. Cl. H02B 1/24

(52) U.S. Cl. 307/115

(57) ABSTRACT

An interface system for medical devices is disclosed. This system provides data communication between one or more medical devices and one or more data processing devices. These data processing devices can be data collection, data analysis, or remote display and control devices, or any combination thereof The invention also provides electrical isolation between the different medical devices and between the medical devices and the data processing devices. This allows clinicians and other health care personnel to connect medical devices to any desired external devices without degrading electrical safety and potentially exposing a patient to hazardous electrical leakage currents.

### FIELD OF THE INVENTION

The present invention relates in general to an interface device for providing communication between medical devices and data processing devices while maintaining patient safety by providing an electrical isolation barrier.

### BACKGROUND OF THE INVENTION

Electrical safety is a priority in the design of any electrically powered product as even relatively small electrical current levels can harm the human body. Current levels as low as 60 milliamps (mA), flowing from one hand to the other in an adult, can cause the heart to go into ventricular fibrillation. Greater currents can cause burns and nerve damage. The magnitude of the current flow, and the commensurate damage caused by exposure to electrical currents, is dependant on a number of different factors. Some of these factors include, the driving voltage, the connection to the body, the frequency of the applied current, the resistance to current flow, and the path the current takes through the body.

Nowhere is this more of a concern than in the design of electronic devices for medical use. In the clinical setting electronic devices are often directly connected to a person and multiple devices may be connected to the same patient at the same time. Compounding the problem is the fact that the many of these connections are highly conductive. Medical devices that are designed to introduce intravenous fluids into the circulatory system are in direct contact with one of the most conductive portions of the human body. Other medical devices are specifically designed to make low resistance contact with the body. These include monitors such as EKG and EEG monitors, and grounding pads for electrosurgery. Also some medical devices connect to a patient internally during surgery and therefore present the possibility of high current densities induced to particularly vulnerable organ systems in a highly electrically conductive environment. Furthermore the patient who is connected to all these instruments may be anesthetized or unconscious and thus unable to respond normally to an electrical shock.

To ensure patient safety, high leakage current levels and unintended current paths through the patient must be prevented. Thus strict regulations and standards are in place for the design and manufacture of electronic devices and a device manufacturer must demonstrate compliance with such regulations prior to the release of a new device to the medical marketplace. In some medical devices the allowable leakage current levels can be as low as 50 micoamps (uA).

In actual usage of medical devices there exists an additional complicating factor that is somewhat difficult to control. While all medical devices, at least in most developed nations, have to meet strict standards for electrical safety, the instruments that can be connected to these medical devices are not required to meet the same stringent safety levels as are medical devices. Many medical devices have the capability to connect to a variety of data processing instruments for data collection, data analysis, or remote display and control. These instruments include devices such as computers, strip chart recorders, or data storage devices such as a tape drive. For example most pulse oximeters, used to measure the oxygen saturation in the arterial blood, can connect to a computer for data logging and off line trend analysis. Similarly many EKG devices, blood pressure monitors, cardiac output measurement instrumentation, and other patient connected medical devices have data ports for connection to various data processing instrumentation.

These ports can take a number of different forms. Common data ports include, RS-232, IEEE 488, Universal Serial Bus, Medical Information Bus, Ethernet connection, telephone style connectors, or any one of a number of other standard and non-standard connectors. Once connected to a non-medical data processing device the carefully designed medical instrument may no longer maintain the specified low leakage current levels to which it was originally designed. Further with multiple medical devices attached to a single patient, and several of those devices connected to a variety of non-medical data processing devices, the presence of potentially dangerous leakage current levels and unintended current paths that can include the patient becomes a very real hazard. Currently the only way to assure that such a situation does not occur is to avoid connecting medical devices to any data processing devices when the medical device is also attached to the patient. The problem with this solution is that it prevents real time data analysis of patient data and that it can be very cumbersome to have to disconnect and reconnect the data processing instrumentation for every patient.

Further there are no medical device alarms that alert the clinician to the fact the both a patient and a data processing device are connected to the medical device at the same time. In fact often the only indication that an end user has that they should not connect a medical device to a patient and to a data processing device simultaneously is found buried in some of the operating manuals for medical devices. The potential for unintended connections during patient care therefore is quite high. Thus there has been a long standing need for a means to be able to connect, and to leave connected, data processing devices to medical devices, without the risk of creating excessive leakage currents or of generating unintended current paths that could potentially endanger the patient. Such a means would enhance patient safety and reduce confusion and inconvenience for the end user of such medical devices. Additionally with the ever increasing number of medical devices used simultaneously on any given patient there is a need to be able to collect data from multiple medical devices on a single data processing device and similarly to be able to control any number of medical devices from a single data processing device.

### BRIEF SUMMARY OF THE INVENTION

It is the intent of this invention to provide an interface between medical devices and data processing devices that provides the management of data flow between the two sets of instruments while blocking the flow of leakage currents between any of the devices connected to this interface. This interface will allow a single point of attachment for all medical devices and their associated data processing devices in a given patient care area.

The benefits of such an interface to the end user are in patient safety and convenience. The medical devices may be connected to any desired data processing devices without concern for, or the measurement or calculation of, what the combined leakage currents may have been without the use of this interface. The interface also allows the connections to be maintained during patient care permitting real time data acquisition and analysis of patient data. Also the clinician is no longer required to remember to disconnect the data processing devices when treating a patient, nor do they have to be concerned about the potential consequences of forgetting to do so.

The data interface of this invention provides a number of input and output data ports. The input data ports of the interface are defined as the intended connections to the medical devices. The output data ports of the interface are defined as the intended connections to the data processing devices. The data ports themselves can be either connectors into which any of these devices can be plugged in or connected, or they can consist of cables which are used to plug into the data ports on the medical devices or on the data processing devices. In either case the data ports on the data interface device of this invention will typically be in the form of a male or female connector of the type necessary to connect to any of the common or custom data connectors used in medical instrumentation and data processing instrumentation. Some of the common connector types include, RS-232, IEEE488, Universal Serial Bus, Medical Information Bus, Ethernet connection, and telephone style connectors.

In the preferred embodiment of this device every input data port on the data interface of this invention is electrically isolated from every other data port through the use of optical or magnetic coupling. This allows only the signals to be coupled from the input to the output of the interface, or from the output to the input, but blocks any current flow between any two connections. Thus the interface electrically isolates or separates each connection of any of its input data ports from any other data port. The interface also provides electrical isolation of its power source from any of its data ports. (In an alternative configuration of the instrument the input data ports are not electrically isolated from each other but only from the output data ports or any other portion of the included circuitry.) The electrical isolation provided by this device allows clinicians and other end users of medical devices to connect these medical devices to any desired data processing devices, and to leave them connected to such devices even during patient use, without concern for the electrical safety of non-medical devices used in combination with medical devices.

It is a further aspect of this invention to provide a means for connection of two or more medical devices to any given data processing device or to allow for the connection of two or more data processing devices to any given medical device. This additional function of this instrument can occur in one of two ways. The data interface could simply provide parallel connection from several input ports to a single output port, or several output ports to a single input port. Of course this would still be done through the appropriate optical or magnetic coupling to ensure the electrical isolation between any two connected devices is maintained. The other way this could be provided is through the use of a microprocessor integral to the data interface device that would monitor and control data flow between inputs and outputs routing data from any input data ports to any output data ports in accordance with its programming. Thus it could provide data from any given input port to any given set of output ports or visa versa under software control. This allows the user of the data interface to alter the connection configuration any time the need arises without the need for a hardware modification to the data interface.

In the preferred embodiment of the version of the data interface that allows user configurable connection of input data ports to output data ports, the user controls the configuration by temporary connection to an external computer. A software program allows the user to download the desired port-to-port mapping to the data interface, which is then stored in non-volatile memory within the data interface. While this is the preferred embodiment of this implementation, it should be noted that there are a wide variety of methods that could be utilized to accomplish this function including a collection of bit switches integral to the data interface that could be set by hand to control the port-to-port mapping. This configuration would have the advantage of allowing the configuration of the data interface to be altered at any time without the need to connect to an external computer.

### BRIEF DESCRIPTION OF THE DRAWINGS

FIG. 1 Shows the electrical isolation block diagram for the invention defining the isolation barriers and the minimum electrical isolation provided by each of the barriers.

FIG. 2 is a drawing of the basic configuration of the invention including magnetic and optical isolation barriers between data ports and between the power supply and the rest of the circuitry.

FIG. 3 shows an alternative configuration of the invention where the input and output data ports do not maintain a one-to-one mapping.

FIG. 4 shows another way to implement the port mapping shown in FIG. 3 where the data flow is under microprocessor-control.

### DETAILED DESCRIPTION OF THE INVENTION

Irrespective of the exact configuration of this data interface device, in terms of the number or types of data ports used, or in terms of how data flow is mapped from the input ports to the output ports, the key function of the device is to enhance patient safety by preventing electrical connection of non-medical devices connected to the output data ports through to the medical devices connected to the input data ports. This is achieved in the data interface device of this invention by implementation of electrical isolation boundaries between various portions of the device. Such boundaries are created by physically separating, or isolating, the circuitry on the two sides of the barrier by a dielectric, or insulating material, of sufficient strength to block current flow from one side of the boundary to the other. The strength of the electrical isolation created by the boundary is rated by the magnitude of the voltage differential across the boundary at which current flow across the boundary is still blocked. To pass signals from one side of the boundary to the other the signals are coupled across the boundaries by means of optical or magnetic coupling devices such as opto-isolators or transformers.

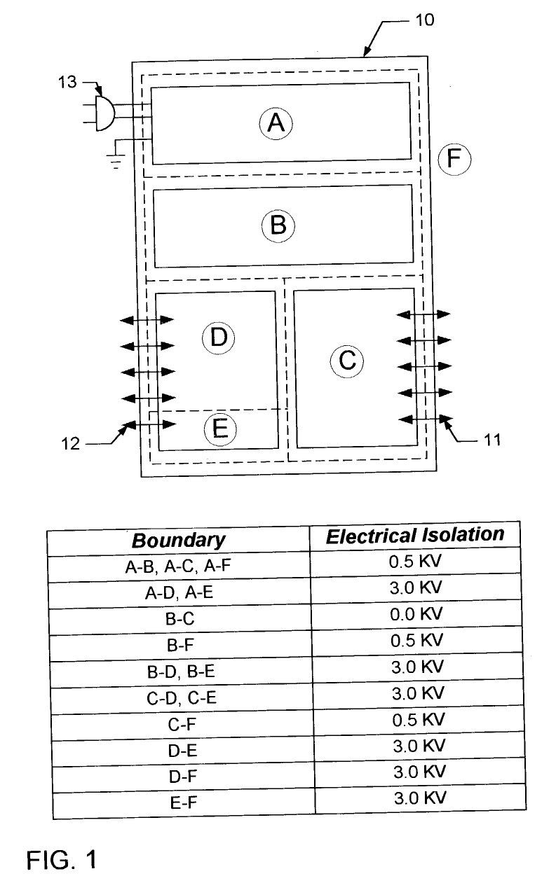

The generalized Electrical Isolation Block Diagram of this invention is shown in FIG. 1. The data interface device 10 contains several different portions or sections indicated by the letters A through F in the circles. These sections are electrically isolated from each other as shown in the Electrical Isolation Table shown in the bottom half of FIG. 1. Section A is the primary side of the power supply for the device and Section B is the secondary or “intermediate circuit” side. As indicated by the Electrical Isolation Table, sections A and B are isolated from each other by a minimum of 500 volts (or 0.5 KV). This physical isolation boundary also provides electrical isolation between the primary side of the power supply and all other portions of the device. Typically the electrical isolation between the primary and the secondary sides of the power supply is created by a physical separation between the primary and secondary sides of a transformer which provides magnetic coupling of the power across the isolation boundary. Section B also houses any of the control circuitry and power distribution circuitry of the device.

Section C is the output data port section. This section includes the connections to the data processing devices as well as an interface to the input data ports and any necessary control logic. There also may be an interface to a control section of circuitry such as a microprocessor section. The output data port connections can be either cables with connectors designed to connect to the various desired data processing devices or they can be connectors mounted directly on the data interface device 10 into which the cables from the various data processing devices are plugged. The data port connections are indicated by the bi-directional arrows 11 which are used to indicate that the data flow is also bi-directional.

Section D (and E) is the input data port section. This section includes the connections to the medical devices as well as an interface to the output data ports and any necessary control logic. The connections to the medical devices can be either cables with connectors designed to connect to the various desired medical devices or they can be connectors mounted directly on the data interface device 10 into which the cables from the various medical devices are plugged. The data port connections are indicated by the bi-directional arrows 12 which are used to indicate that the data flow is also bi-directional. As shown in the Electrical Isolation Table, a minimum of 3000 volts of isolation is maintained between the data ports of this section and any other portion of the device.

The interface device of this invention may or may not be constructed to provide electrical isolation between the individual input data ports of section D. Section E shows how isolation would be provided when isolation is desired between the individual data ports of this section. In this case, as shown in the Electrical Isolation Table, 3000 volts of isolation would also be provided between Section E and any other portion of the instrument including the other input data ports.

The last section is section F which indicates the device housing (or the exterior surface of the device) including any user accessible metal parts on the housing, of the interface device. These metal contacts are isolated from any enclosed circuitry (or the circuitry internal to the device) by a minimum of 500 volts and from the input data ports by a minimum of 3000 volts. Accessible metal parts might include metal pieces on connectors, metal screw or bolt heads, or any other metal parts on the outside of the device to which a user of the device could make contact.

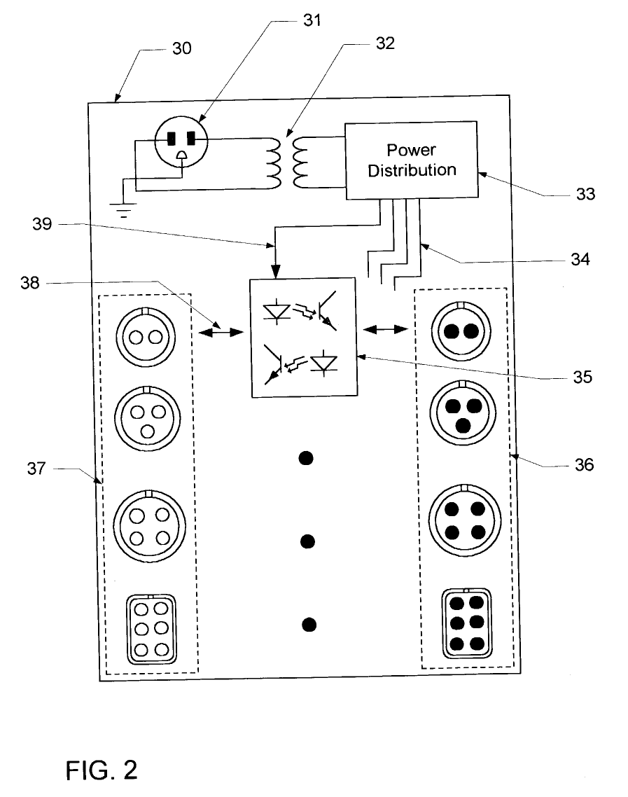

This Electrical Isolation Diagram applies to any actual implementations of this invention. Thus the sections shown in the various potential implementations of this device, that are sketched in FIG. 2 through FIG. 4, are isolated from each other or from user contact as defined in this diagram. Any metal parts which are electrically connected to any of the enclosed electronic circuits, in any given section, are also electrically isolated as specified in the block diagram of FIG. 1 and the included Electrical Isolation Table.

FIG. 2 is a sketch of the interface device 30 of this invention in its most basic form. In this diagram 31 is the input AC power receptacle going to the primary side of the power supply section of the device. Transformer 32 separates, and electrically isolates, the primary from the secondary side of the power supply section.

The power distribution section 33 provides power to the opto-coupling portions 35 of the input data port sections and the output data ports sections of the device. In the preferred embodiment of this device each input data port is electrically isolated from every other input data port by 3000V. Therefore the power provided to run the optical isolation circuitry on any given input data port 39 must provide 3000 volts of isolation from the power provided anywhere else by the power distribution section 33. This is not necessarily true on the output data port side of the same opto-coupling circuitry. Power provided by the power distribution section 33 to the output data ports side of the opto-coupling circuitry 35 may be provided by a single line to all the opto-couplers on the output data port side, as this side of the opto-couplers do not necessarily need to be electrically isolated from one another. Power distribution to the output data port side of the system and to other portions of the data interface device is indicated by the lines pointed to by arrow 34. If electrical isolation is required, as it is for the input data port side of opto-coupler 39, individual DC-to-DC converters internal to the power distribution section 33 provide the necessary additional isolation.

The bi-directional arrows 38 show the bi-directional data flow that occurs between the connectors of the input data ports 37 and the opto-coupling section 35 and the bi-directional data flow between the connectors of the output data ports 36 and the opto-coupling section 35. For clarity only one set of bi-directional arrows and one opto-coupler is shown. The dots below these symbols are meant to indicate the repetition of these symbols as needed; one set for each physical input and output connector pair in the data ports. The symbols in the opto-coupler 35 are used to indicate that data flow occurs in both directions through the opto-coupler and may consist of as many opto-coupling devices as are needed to couple the data from the input data port connector to the output data port connector and visa versa. For example 8 opto-couplers may be required for each direction of data transmission across an isolation boundary if the data port is an 8-bit parallel data port configuration.

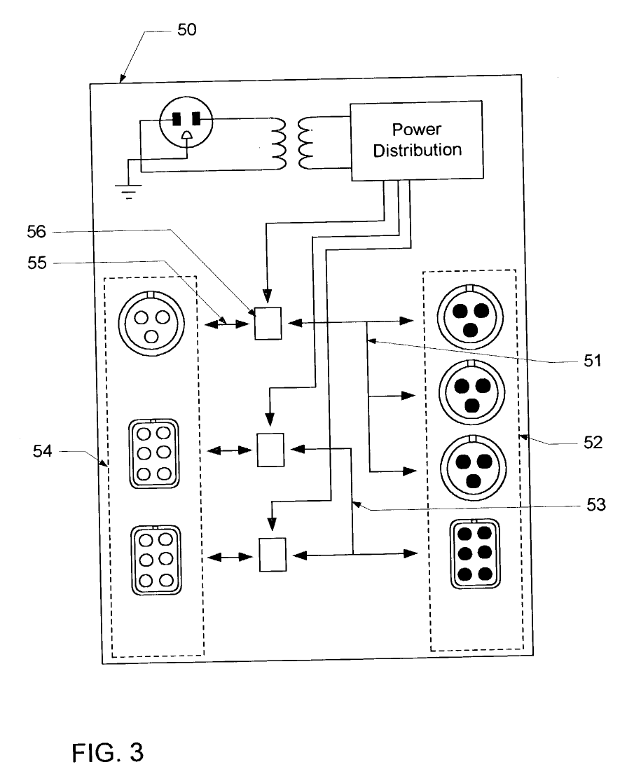

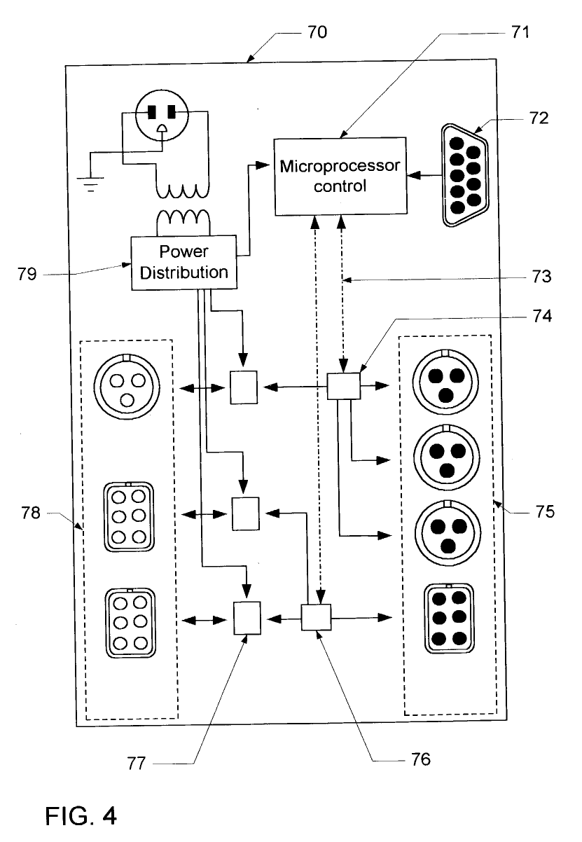

In FIG. 3 a configuration of the invention is sketched in which two input data port connectors 54 are mapped, or connected, to one of the output data port connectors 52 as indicated by the bi-directional arrows 53. Also one input data port connector is mapped to three output data port connectors as indicated by the bi-directional arrows 51. Again the opto-couplers 56 (arrow points to one of three) provide electrical isolation of any given input data port from any other input data port as well as from any other portion of the systems' circuitry. Note that any connections provided between multiple connectors are made on the output data port side of the system to assure correct electrical isolation of the patient-critical side, that is, the input data ports. This configuration allows one computer, for example, to control more than one medical device or allows multiple data processing devices to collect data from a single medical device. It should be obvious that the mapping from input data ports to output data ports, as well as the number of each, shown in these figures is only an example and a device with virtually any number of input or output data ports and any predetermined mapping (or programmable mapping, as will be shown in FIG. 4) could be designed and built under this invention.

In FIG. 4 the interface device 70 configuration has the same mapping between the input data ports and the output data ports as the configuration shown in FIG. 3 but in this case a microprocessor-controlled subsystem 71 has been added. The purpose of this addition is to allow software control of communication between the input data port connectors 78 and the output data port connectors 75. This control has two primary components, data tagging and port switching.

As data flows from the input port side to the output port side the microprocessor-controlled subsystem adds a tag to indicate which input data port the data comes from. That way when multiple input data ports map into one or more output data ports, the data processing devices connected to those output data ports can identify which data it receives, comes from which specific input data port,and therefore from which specific medical device. Similarly when data is sent from a single data processing device to any one of a number of medical devices the microprocessor-controlled subsystem can look for the tag to determine which specific input data port the data should be directed to. This tag can be a simple string of data that uniquely specifies a given data port. The microprocessor would also handle all necessary buffering to prevent any contention on the communication, or bus, lines.

The function of port switching is controlled by the microprocessor sending signals to a switching network which in FIG. 4 is indicated by the boxes 74 and 76. This switching network would allow for software control of which input data ports are mapped to which output data ports.

In order to program the microprocessor-controlled subsystem 71 a connector 72 has been added that allows connection to a computer to download to subsystem 71 which ports should be connected to which and what tags, or unique identifiers, should be, or will be, appended to the data coming from which specific input data ports.

In any of the configurations previously described the power source for the internal circuitry of the data interface of this invention can come from any one of a number of different places or two or more may be used in combination. As shown in the drawings, AC power may be used. Additionally the system may be battery powered or an internal battery may just provide back-up power for when AC power is disconnected. An alternative source of power for the system, whether primary or secondary, may also come from the data processing devices to which it is connected. For example, the data interface may draw power from a USB port on a computer, to which it is connected, to power the device. This would eliminate the need for a separate cable to connect to the AC line power.

Also in any of the configurations previously described a number of indicator lights, such as LEDs, may be included which provide visual feedback to the end user of the product. Such lights may indicate connection to AC power, data line activity, battery power level, or other status information of the instrument. Indicator lights may also be configured to show the port mapping that the device is programmed to deliver thus providing a visual confirmation of programming changes.

Regardless of the exact configuration of the device, the electrical isolation of the input data ports from the rest of the device, and from any devices connected to it, allow end users to connect medical devices to data processing devices without concern for the electrical properties of those non-medical devices or the need to disconnect non-medical devices from the medical devices during patient care. This increases patient safety and reduces the burden of equipment maintenance on the health care provider.

The previous discussion of the invention has been presented for the purposes of illustration and description. The description is not intended to limit the invention to the form disclosed herein. Variations and modifications commensurate with the above are considered to be within the scope of the present invention. The embodiment described herein is further intended to explain the best mode presently known of practicing the invention and to enable others skilled in the art to utilize the invention as such, or in other embodiments, and with the particular modifications required by their particular application or uses of the invention. It is intended that the appended claims be construed to include alternative embodiments to the extent permitted by the prior art.

1) an apparatus comprising:
a housing enclosing circuitry,
at least one input data port in said housing for connection to at least one medical device;
at least one output data port in said housing for connection to at least one data processing device;
an isolation circuit that connects said at least one input data port to said at least one output data port;
said isolation circuit providing a minimum of 3000 volts of electrical isolation between said at least one input data port and said at least one output data port or any other said enclosed circuitry within said housing.

2) The apparatus as claimed in claim 1 wherein said housing encloses electrically connected metal parts and said housing prevents user contact to any said electrically connected metal parts.

3) The apparatus as claimed in claim 2 wherein said housing includes accessible metal parts and said accessible metal parts are isolated by a minimum of 500 volts from any said enclosed circuitry.

4) The apparatus as claimed in claim 1 wherein said at least one input data port and said at least one output data port consist of one or more of Ethernet, RS-232, IEEE 488, Universal Serial Bus, Medical Information Bus, or Telephone style connectors.

5) The apparatus as claimed in claim 1 wherein any one of said at least one input data port is mapped to at least two of said output data ports.

6) The apparatus as claimed in claim 1 wherein said at least one output data port is mapped to at least two of said input data ports.

7) The apparatus as claimed in claim 6 wherein said enclosed circuitry appends a tag to data being communicated between said at least one output data port and said mapped at least two input data ports.

8) The apparatus as claimed in claim 7 wherein data received from said data processing device at any of said at least one output data ports is distributed to specific said input data ports in accordance with the information contained in said tag appended to said data.

9) The apparatus as claimed in claim 5 wherein said enclosed circuitry appends a tag to data being communicated between said at least one input data port and said mapped at least two output data ports.

10) The apparatus as claimed in claim 1 wherein an AC line power supply is utilized to power said apparatus and a minimum of at least 500V of electrical isolation is provided between said AC line power supply and any of said at least one input data port or said at least one output data port or any other part of said enclosed circuitry.

11) The apparatus as claimed in claim 1 wherein power for said apparatus is provided by one of said at least one data processing device or one of said at least one medical device connected to said apparatus.

12) The apparatus as claimed in claim 1 wherein said apparatus includes back up power or primary power provided by one or more batteries.

13) The apparatus as claimed in claim 1 wherein said apparatus includes at least one visual display to provide status information.

14) The apparatus as claimed in claim 1 wherein there is a plurality of said input data ports and wherein each of said input data ports is electrically isolated from all other said input data ports.

15) In a data interface containing electronic circuitry, a method for providing electrical isolation comprising the steps of:
providing at least one input data port in said data interface for connection to at least one medical device;
providing at least one output data port in said data interface for connection to at least one data processing device;
connecting said at least one input data port to said at least one output data port;
said connecting step providing a minimum of 3000 volts of electrical isolation between said at least one input data port and said at least one output data port or any other said electronic circuitry in said data interface;

16) The method of claim 15, wherein said data interface contains electrically connected metal parts, further comprising the step of providing a housing which encloses said data interface and that physically prevents the user from making contact to any said electrically connected metal parts.

17) The method of claim 15, wherein said data interface is contained within a housing which includes electrically accessible metal parts, further comprising the step of isolating said housing and any said accessible metal parts by a minimum of 500 volts from any said electronic circuitry contained within said data interface.

18) The method of claim 15 further comprising the step of selecting said at least one input data port and said at least one output data port to consist of one or more of Ethernet, RS-232, IEEE 488, Universal Serial Bus, Medical Information Bus, or Telephone style connectors.

19) The method of claim 15 further comprising the step of mapping any one of said at least one input data port to two or more of said output data ports.

20) The method of claim 15 further comprising the step of mapping any one of said at least one output data port to two or more of said input data ports.

21) The method of claim 20 further comprising the step of appending a tag to the data being communicated between said at least one input data port and said mapped at least two output data ports

22) The method of claim 21 further comprising the step of distributing data received at any of said at least one output data port to specific said input data ports in accordance with the information contained in said tag appended to said data.

23) The method of claim 19 further comprising the step of appending a tag to the data being communicated between said at least one output data port and said mapped at least two input data ports.

24) The method of claim 15 further comprising the step of providing AC line power to power said data interface and further providing 500V of electrical isolation between AC power and any of said at least one input data port or said at least one output data port or any other part of said enclosed circuitry.

25) The method of claim 15 further comprising the step of drawing power for said data interface from one of said at least one input data port connected to one of said at least one medical device or from one of said output data port connected to one of said at least one data processing device.

26) The method of claim 15 further comprising the step of providing back up power or primary power from one or more batteries.

27) The method of claim 15 further comprising the step of providing at least one visual display of status information.

28) The method of claim 15, wherein there is a plurality of said input data ports, further comprising the step of electrically isolating each of said input data ports from all other said input data ports.
